(19) United States
(12) Patent Application Publication
(10) Pub. No.: US 2019/0390897 A1
(43) Pub. Date: Dec. 26, 2019

(54) INTELLIGENT REFRIGERATOR AND METHOD FOR CONTROLLING THE SAME

(71) Applicant: LG ELECTRONICS INC., Seoul (KR)

(72) Inventors: Myunghee LEE, Seoul (KR); Sungjin KIM, Seoul (KR)

(73) Assignee: LG ELECTRONICS INC., Seoul (KR)

(21) Appl. No.: 16/555,981

(22) Filed: Aug. 29, 2019

(30) Foreign Application Priority Data
Aug. 6, 2019 (KR) 10-2019-0095534

(51) Int. Cl. F25D 29/00; H04W 56/00; H04L 5/00; H04W 72/12; G05B 13/02; B65G 43/08; F25D 11/02; F25D 25/04

(52) U.S. Cl. CPC F25D 29/003; H04W 56/001; H04L 5/0048; H04W 72/1289; G05B 13/0265; F25D 2600/02; F25D 11/02; F25D 25/04; F25D 2500/04; F25D 2500/06; B65G 43/08

(57) ABSTRACT

Provided is an intelligent refrigerator. The intelligent refrigerator includes a rail provided at a lower end portion of a tray in which a fruit are stored in a refrigerating compartment to control movement of the fruit between a first zone and a second zone of the tray, and a controller may control movement of the rail such that a fruit selected on the basis of the fruit consumption pattern information is moved from the first zone to the second zone on the basis of the fruit consumption pattern information at a specific time point predicted on the basis of meal pattern information of the user. The second zone is a space in which a temperature is controlled so that the fruit has the highest sugar content value on the basis of the highest sugar content temperature information.

The washing machine may be associated with an artificial intelligence (AI) module, an unmanned aerial vehicle (UAV) (or drone), a robot, an augmented reality (AR) device, a virtual reality (VR) device, and a device related to a 5G service.

This application claims the benefit of Korea Patent Application No. 10-2019-0095534 filed on Aug. 6, 2019, which is incorporated herein by reference for all purposes as if fully set forth herein.

### BACKGROUND OF THE INVENTION

### Field of the Invention

The present invention relates to an intelligent refrigerator and a method for controlling the same, and more particularly, to an intelligent refrigerator for allowing a fruit provided to a user to have the highest sugar content value, and a method for controlling the same.

### Related Art

A refrigerator, which is an apparatus that stores food at low temperatures to prevent food from spoiling, may keep food refrigerated or frozen. The inside of the refrigerator may be generally divided into a refrigerator compartment and a freezer compartment, and the refrigerator includes a heat exchanger for supplying cold air to the inside of the refrigerator.

The cool air supplied to the inside of the refrigerator is generated by a heat exchange action of a refrigerant in a heat exchanger. In other words, cold air is produced by repetition of a cycle of compression-condensation-expansion-evaporation in the heat exchanger and supplied into the refrigerator. The supplied cold air is evenly transferred to the inside of the refrigerator by convection so that food in the refrigerator may be stored at a desired temperature.

Meanwhile, the refrigerator body generally has a rectangular parallelepiped shape with an open front surface, and a refrigerating chamber and a freezing chamber may be provided inside a main body. In addition, a front side of the main body may be provided with a refrigerating chamber door and a freezing chamber door for selectively shielding an opening, and a plurality of drawers, shelves, and storage boxes for storing various foods in an optimal state may be provided in the storage space in the refrigerator.

In a related art, a fruit is unnecessarily at low temperatures at the time for the user to consume the fruit kept in the storage space in the refrigerator, and thus, the fruit provided to the user who consumes the fruit cannot have the highest sugar content value. Therefore, in order to consume the fruit in a state having the highest sugar content value, the user must take the fruit out of the refrigerator before consuming it.

In order to alleviate the inconvenience, the present invention provides a fruit storage method using an artificial intelligence (AI) device to provide a fruit having the highest sugar content at a time when the user of the refrigerator consumes the fruit kept in storage in the refrigerator.

### SUMMARY OF THE INVENTION

The present invention aims to solve the above-mentioned necessity and/or problems.

An aspect of the present invention is to implement a method for providing a fruit having the highest sugar content value at a time when a user of a user of the refrigerator consumes the fruit.

Another aspect of the present invention is to implement a method of learning a meal pattern of a user of a refrigerator in order to provide a fruit having the highest sugar content value at a time when the user consumes the fruit.

Another aspect of the present invention is to implement a method for learning an after-meal fruit consumption pattern of a user of a refrigerator to provide a fruit having the highest sugar content value at a time when the user consumes the fruit.

Another aspect of the present invention is to implement a method of providing a fruit having the highest sugar content value on the basis of a meal pattern of a user and an after-meal fruit consumption pattern of the user.

Technical tasks obtainable from the present invention are not limited by the above-mentioned technical task and other unmentioned technical tasks can be clearly understood from the following description by those having ordinary skill in the art to which the present invention pertains.

In an aspect, an intelligent refrigerator includes: a refrigerator compartment; a memory storing meal pattern information of a user, fruit consumption pattern information, and highest sugar content temperature information; a tray in which a fruit is stored in the refrigerator compartment; a rail provided at a lower end portion of the tray and controlling movement of the fruit between a first zone and a second zone of the tray; and a controller controlling movement of the rail so that a fruit selected on the basis of the fruit consumption pattern information is moved from the first zone to the second zone at a specific time point predicted on the basis of the meal pattern information of the user, wherein the second zone is a space in which a temperature is controlled so that the fruit has a highest sugar content value on the basis of the highest sugar content temperature information.

The meal pattern information may include information in which information on a meal start time point, a meal end time point, and a meal required time of the user recorded by meals is listed by specific dates.

The fruit consumption pattern information may include at least one of date information on which the user consumes a specific fruit, type information of the specific fruit, and information on the consumed number of the specific fruit.

The highest sugar content temperature information may include information in which a temperature at which a specific fruit has the highest sugar content value is listed by fruits.

The first zone may be a space in which a temperature is controlled to maximize a storage period of the fruit.

The memory may further store a highest sugar content value arrival time information listing a time taken for a specific fruit to reach a temperature having a highest sugar content value from a specific temperature by fruit types, and the controller may calculate the highest sugar content value arrival time required for the fruit to reach a temperature having the highest sugar content value from a temperature of the first zone on the basis of the highest sugar content value arrival time information.

If the highest sugar content value arrival time is shorter than the meal required time of the user, the specific time point may be later than the meal start time of the user.

If the highest sugar content value arrival time is longer than the meal required time, the specific time point may be earlier than the meal start time of the user.

If the highest sugar content value arrival time is equal to the meal required time of the user, the specific time point may be equal to the meal start time of the user.

The intelligent refrigerator may further include: a camera detecting that the user starts to have a meal.

The controller may identify a type of the fruit moved to the second zone.

The controller may identify the type of the fruit on the basis of the fruit consumption pattern information.

The intelligent refrigerator may further include: a fruit recognition sensor, wherein the controller may control the fruit recognition sensor to identify the type of the fruit.

The controller may control the rail to move the fruit of the second zone to the first zone if the user does not consume the fruit for a predetermined time after the meal end time point.

The intelligent refrigerator may further include: a communication unit, wherein the controller may control the communication unit to receive downlink control information (DCI) used for scheduling transmission of information on the type of the fruit from a network, and the information on the type of the fruit may be transmitted to the network on the basis of the DCI.

The controller may control the communication unit to perform an initial access procedure with the network on the basis of a synchronization signal block (SSB), the information on the type of the fruit may be transmitted to the network through a physical uplink shared channel (PUSCH), and the SSB and a demodulation reference signal (DM-RS) of the PUSCH may be quasi-co-located, QCL, for a QCL type D.

The controller may control the communication unit to transmit information on the type of the fruit to an AI processor included in the network, and the controller may control the communication unit to receive the highest sugar content temperature information in which information regarding the type of the fruit is AI-processed from the AI processor.

According to another aspect of the present invention, there is provided a fruit storage method using an artificial intelligence device, including: selecting a specific fruit to be moved from a first zone to a second zone of a tray storing a fruit in a refrigerating compartment on the basis of fruit consumption pattern information of a user; moving the specific fruit from the first zone to the second zone through a rail provided at a lower end portion of the tray at a specific time point predicted on the basis of meal pattern information of the user; and setting a temperature of the second zone such that the fruit has the highest sugar content value on the basis of the highest sugar content temperature information.

The method may further include: calculating a highest sugar content value arrival time required for a specific fruit to reach a temperature having a highest sugar content value from a temperature of the first zone on the basis of the highest sugar content value arrival time information listing a time for the specific fruit to reach the temperature having the highest sugar content value from a specific temperature by fruit types.

The method may further include: moving the specific fruit from the second zone to the first zone if the user does not consume the specific fruit for a predetermined time after the meal end time point.

### BRIEF DESCRIPTION OF THE DRAWINGS

FIG. 1 illustrates one embodiment of an AI device.

FIG. 2 illustrates a block diagram of a wireless communication system to which the methods proposed herein may be applied.

FIG. 3 illustrates an example of a signal transmission/reception method in a wireless communication system.

FIG. 4 is a block diagram of an AI device according to an embodiment of the present invention.

FIG. 5 shows an example of a refrigerator according to an embodiment of the present invention.

FIG. 6 is a block diagram of a refrigerator for performing a fruit storage method using an AI device according to an embodiment of the present invention.

FIG. 7 is a flowchart illustrating an example of a fruit storage method using an AI device according to an embodiment of the present invention.

FIG. 8 is a view illustrating an example of performing a fruit storage method using an AI device according to an embodiment of the present invention.

FIG. 9 is a view illustrating an example of performing a fruit storage method using an AI device according to an embodiment of the present invention.

FIG. 10 is a view illustrating an example of performing a fruit storage method using an AI device according to an embodiment of the present invention.

FIG. 11 is a view illustrating an example of performing a fruit storage method using an AI device according to an embodiment of the present invention.

FIG. 12 is a view illustrating another example of performing a fruit storage method using an AI device according to an embodiment of the present invention.

FIG. 13 is a view illustrating an example of performing a fruit storage method using an AI device according to an embodiment of the present invention.

FIG. 14 is a view illustrating another example of performing a fruit storage method using an AI device according to an embodiment of the present invention.

FIG. 15 is a flowchart illustrating an example of performing a fruit storage method using an AI device according to an embodiment of the present invention.

FIG. 16 is a view illustrating an example of performing a fruit storage method using an AI device according to an embodiment of the present invention.

FIG. 17 is a flowchart illustrating an example of a fruit storage method using an AI device according to an embodiment of the present invention.

FIG. 18 is a flowchart illustrating an example of a fruit storage method using an AI device according to an embodiment of the present invention.

The accompanying drawings, which are included as part of the detailed description in order to provide a thorough understanding of the present invention, provide embodiments of the present invention and describe the technical features of the present invention together with the description.

### DESCRIPTION OF EXEMPLARY EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present invention would unnecessarily obscure the gist of the present invention, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

Hereinafter, 5G communication (5th generation mobile communication) required by an apparatus requiring AI processed information and/or an AI processor will be described through paragraphs A through G.

A. Example of Block Diagram of UE and 5G Network

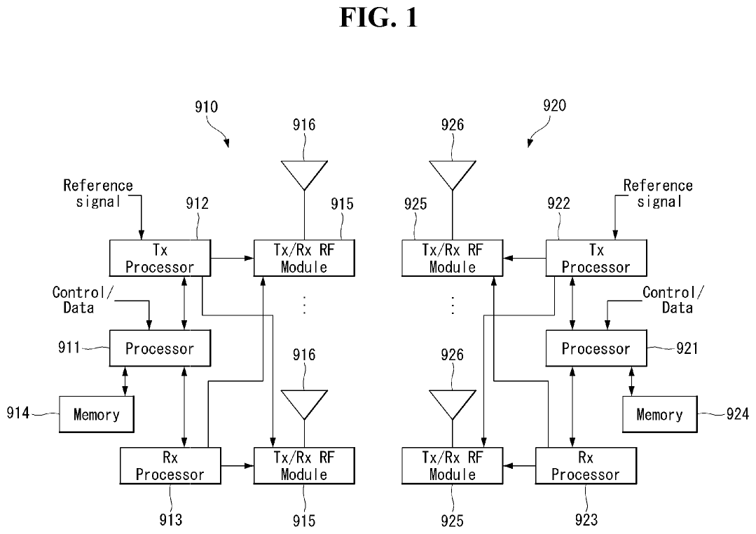

FIG. 1 is a block diagram of a wireless communication system to which methods proposed in the disclosure are applicable.

Referring to FIG. 1, a device (autonomous device) including an autonomous module is defined as a first communication device (910 of FIG. 1), and a processor 911 can perform detailed autonomous operations.

A 5G network including another vehicle communicating with the autonomous device is defined as a second communication device (920 of FIG. 1), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like.

For example, the first communication device or the second communication device may be a base station, a network node, a transmission terminal, a reception terminal, a wireless device, a wireless communication device, a vehicle, a vehicle having an autonomous function, a connected car, a drone (Unmanned Aerial Vehicle, UAV), and AI (Artificial Intelligence) module, a robot, an AR (Augmented Reality) device, a VR (Virtual Reality) device, an MR (Mixed Reality) device, a hologram device, a public safety device, an MTC device, an IoT device, a medical device, a Fin Tech device (or financial device), a security device, a climate/environment device, a device associated with 5G services, or other devices associated with the fourth industrial revolution field.

For example, a terminal or user equipment (UE) may include a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. For example, the drone may be a flying object that flies by wireless control signals without a person therein. For example, the VR device may include a device that implements objects or backgrounds of a virtual world. For example, the AR device may include a device that connects and implements objects or background of a virtual world to objects, backgrounds, or the like of a real world. For example, the MR device may include a device that unites and implements objects or background of a virtual world to objects, backgrounds, or the like of a real world. For example, the hologram device may include a device that implements 360-degree 3D images by recording and playing 3D information using the interference phenomenon of light that is generated by two lasers meeting each other which is called holography. For example, the public safety device may include an image repeater or an imaging device that can be worn on the body of a user. For example, the MTC device and the IoT device may be devices that do not require direct interference or operation by a person. For example, the MTC device and the IoT device may include a smart meter, a bending machine, a thermometer, a smart bulb, a door lock, various sensors, or the like. For example, the medical device may be a device that is used to diagnose, treat, attenuate, remove, or prevent diseases. For example, the medical device may be a device that is used to diagnose, treat, attenuate, or correct injuries or disorders. For example, the medial device may be a device that is used to examine, replace, or change structures or functions. For example, the medical device may be a device that is used to control pregnancy. For example, the medical device may include a device for medical treatment, a device for operations, a device for (external) diagnose, a hearing aid, an operation device, or the like. For example, the security device may be a device that is installed to prevent a danger that is likely to occur and to keep safety. For example, the security device may be a camera, a CCTV, a recorder, a black box, or the like. For example, the Fin Tech device may be a device that can provide financial services such as mobile payment.

Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

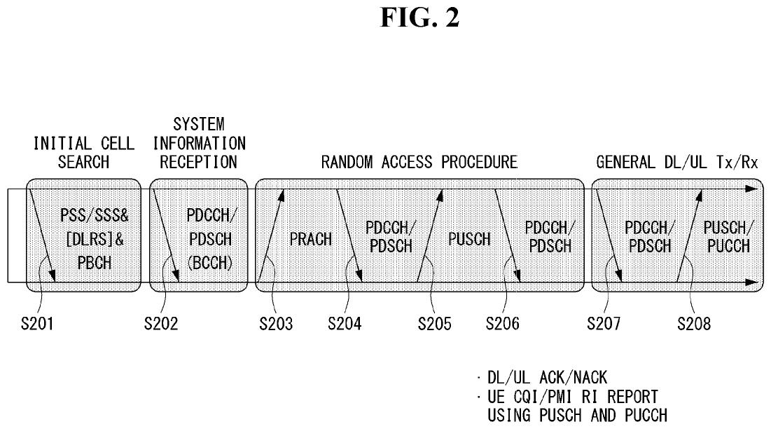

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

An UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSB×1, SSB×2, SSB×3, SSB×4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof.
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationlnfo is set for SRS resources, the same beamforming as that used for the SSB, CSI-RS or SRS is applied. However, when SRS-SpatialRelationlnfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation of AI Using 5G Communication

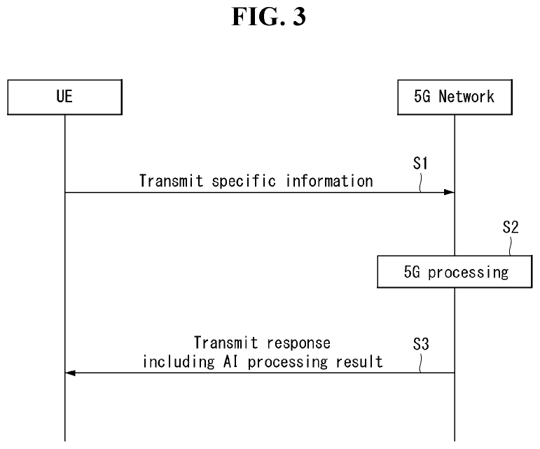

FIG. 3 shows an example of basic operations of an UE and a 5G network in a 5G communication system.

The UE transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the UE (S3).

G. Applied Operations Between UE and 5G Network in 5G Communication System

Hereinafter, the operation of an UE using 5G communication will be described in more detail with reference to wireless communication technology (BM procedure, URLLC, mMTC, etc.) described in FIGS. 1 and 2.

First, a basic procedure of an applied operation to which a method proposed by the present invention which will be described later and eMBB of 5G communication are applied will be described.

As in steps S1 and S3 of FIG. 3, the UE performs an initial access procedure and a random access procedure with the 5G network prior to step S1 of FIG. 3 in order to transmit/receive signals, information and the like to/from the 5G network.

More specifically, the UE performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the UE receives a signal from the 5G network.

In addition, the UE performs a random access procedure with the 5G network for UL synchronization acquisition and/or UL transmission. The 5G network can transmit, to the UE, a UL grant for scheduling transmission of specific information. Accordingly, the UE transmits the specific information to the 5G network on the basis of the UL grant. In addition, the 5G network transmits, to the UE, a DL grant for scheduling transmission of 5G processing results with respect to the specific information. Accordingly, the 5G network can transmit, to the UE, information (or a signal) related to remote control on the basis of the DL grant.

Next, a basic procedure of an applied operation to which a method proposed by the present invention which will be described later and URLLC of 5G communication are applied will be described.

As described above, an UE can receive DownlinkPreemption IE from the 5G network after the UE performs an initial access procedure and/or a random access procedure with the 5G network. Then, the UE receives DCI format 2_1 including a preemption indication from the 5G network on the basis of DownlinkPreemption IE. The UE does not perform (or expect or assume) reception of eMBB data in resources (PRBs and/or OFDM symbols) indicated by the preemption indication. Thereafter, when the UE needs to transmit specific information, the UE can receive a UL grant from the 5G network.

Next, a basic procedure of an applied operation to which a method proposed by the present invention which will be described later and mMTC of 5G communication are applied will be described.

Description will focus on parts in the steps of FIG. 3 which are changed according to application of mMTC.

In step S1 of FIG. 3, the UE receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the UE transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

The above-described 5G communication technology can be combined with methods proposed in the present invention which will be described later and applied or can complement the methods proposed in the present invention to make technical features of the methods concrete and clear.

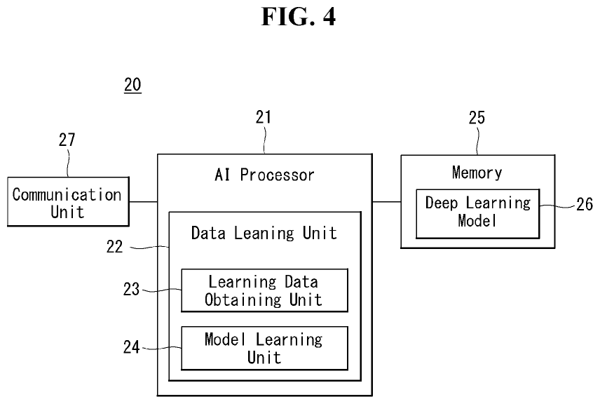

FIG. 4 is a block diagram of an AI device according to an embodiment of the present invention.

The AI device 20 may include an electronic device including an AI module capable of performing AI processing or a server including the AI module. In addition, the AI device 20 may be included as a component of a part of a specific device and provided to perform at least a part of AI processing together.

The AI processing may include all operations related to a method provided in the present invention.

The AI device 20 may include an AI processor 21, a memory 25, and/or a communication unit 27.

The AI device 20, which is a computing device capable of learning a neural network, may be implemented as various electronic devices such as a server, a desktop PC, a notebook PC, a tablet PC, and the like.

The AI processor 21 may learn a neural network using a program stored in the memory 25. In particular, the AI processor 21 may learn a neural network for recognizing data necessary to perform the method provided in the present invention. Here, the neural network for recognizing data necessary to perform the method provided in the present invention may be designed to simulate a human brain structure on a computer and may include a plurality of weighted network nodes that simulate neurons of a human neural network. The plurality of network nodes may transmit and receive data according to connection relationships, respectively, to simulate a synaptic activity of the neurons exchanging signals through synapses. Here, the neural network may include a deep learning model developed from a neural network model. In the deep learning model, a plurality of network nodes may be located on different layers and exchange data according to convolution connection relationships. Examples of neural network models include various deep learning techniques such as deep neural networks (DNN), convolutional deep neural networks (CNN), recurrent Boltzmann machine (RNN), restricted Boltzmann machine (RBM) deep belief networks (DBN), deep-Q-network, and may be applied to fields such as computer vision, speech recognition, natural language processing, voice/signal processing, and the like.

Meanwhile, the processor performing the function described above may be a general-purpose processor (e.g., a CPU) or may be an AI-specific processor (e.g., a GPU) for artificial intelligence learning.

The memory 25 may store various programs and data necessary for the operation of the AI device 20. The memory 25 may be implemented as a nonvolatile memory, a volatile memory, a flash memory, a hard disk drive (HDD), or a solid state drive (SDD). The memory 25 may be accessed by the AI processor 21 and data may be read/written/modified/deleted/updated by the AI processor 21 from the memory 25. The memory 25 may also store a neural network model (e.g., a deep learning model 26) generated through a learning algorithm for data classification/recognition in accordance with an embodiment of the present invention.

Meanwhile, the AI processor 21 may include a data learning unit 22 that learns a neural network for data classification/recognition. The data learning unit 22 may learn criteria regarding what learning data is to be used to determine data classification/recognition and how data is classified and recognized using learning data. The data learning unit 22 may obtain learning data to be used for learning and apply the obtained learning data to the deep learning model, thereby learning the deep learning model.

The data learning unit 22 may be manufactured in the form of at least one hardware chip and mounted in the AI device 20. For example, the data learning unit 22 may be fabricated in the form of a dedicated hardware chip for artificial intelligence (AI) or may be manufactured as a part of a general-purpose processor (CPU) or a graphics-only processor (GPU) and mounted in the AI device 20. The data learning unit 22 may be implemented as a software module. When the data learning unit 22 is implemented as a software module (i.e., program module including instructions), the software module may be stored in a non-transitory computer-readable medium. In this case, at least one software module may be provided by an operating system (OS) or by an application.

The data learning unit 22 may include a learning data obtaining unit 23 and a model learning unit 24.

The learning data obtaining unit 23 may obtain learning data necessary for a neural network model for classifying and recognizing data. For example, the learning data obtaining section 23 may obtain, as learning data, vehicle data and/or sample data to be input to the neural network model.

The model learning unit 24 may learn to have a criterion regarding how the neural network model classifies certain data using the obtained learning data. Here, the model learning unit 24 may train the neural network model (that is, the model learning unit 24 may cause the neural network model to learn) through supervised learning which uses at least part of the learning data as a criterion. Alternatively, the model learning unit 24 may train the neural network model through unsupervised learning that discovers a criterion by learning by itself using learning data without supervision. Also, the model learning unit 24 may train the neural network model through reinforcement learning using feedback on whether a result of determining a situation based learning is correct. Also, the model learning unit 24 may train the neural network model using a learning algorithm including error back-propagation or gradient decent.

When the neural network model is trained, the model learning unit 24 may store the trained neural network model in the memory. The model learning unit 24 may store the trained neural network model in a memory of a server connected to the

AI device 20 via a wired or wireless network.

The data learning unit 22 may further include a learning data preprocessing unit (not shown) and a learning data selecting unit (not shown) to improve an analysis result of a recognition model or to save resources or time necessary to generate the recognition model.

The learning data preprocessing unit may preprocess the obtained data so that the obtained data may be used for learning for situation determination. For example, the learning data preprocessing unit may process the obtained data into a predetermined format so that the model learning unit 24 may use the obtained learning data to learn image recognition.

Further, the learning data selecting unit may select data required for learning from among the learning data obtained by the learning data obtaining unit 23 or the learning data preprocessed by the preprocessing unit. The selected learning data may be provided to the model learning unit 24. For example, the learning data selecting unit may detect a specific zone of an image obtained through a camera of a vehicle and select, as learning data, only data for an object included in the specific zone.

In addition, the data learning unit 22 may further include a model evaluating unit (not shown) to improve the analysis result of the neural network model.

The model evaluating unit may input evaluation data to the neural network model, and if an analysis result output from the evaluation data does not satisfy a predetermined criterion, the model evaluating unit may allow the model leaning unit 22 to learn again. In this case, the evaluation data may be predefined data for evaluating the recognition model. For example, if the number of pieces of evaluation data or a proportion of the evaluation data for which the analysis result is not correct, among the analysis results of the learned recognition model for the evaluation data exceeds a predetermined threshold value, the model evaluating unit may evaluate that the predetermined criterion is not satisfied.

The communication unit 27 may transmit an AI processing result from the AI processor 21 to an external electronic device.

Here, the external electronic device may be defined as an autonomous vehicle. Further, the AI device 20 may be defined as another vehicle or 5G network that communicates with the autonomous module vehicle. Meanwhile, the AI device 20 may be functionally embedded and implemented in an autonomous driving module provided in the vehicle. Further, the 5G network may include a server or a module that performs autonomous driving related control.

Although the AI device 20 shown in FIG. 4 is functionally divided into the AI processor 21, the memory 25, and the communication unit 27, the aforementioned components may be integrated into a single module and referred to as an AI module.

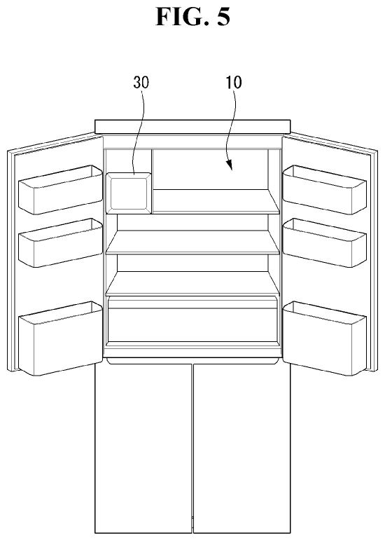

FIG. 5 is a view showing a refrigerator according to an embodiment of the present invention.

A refrigerator 1 according to an embodiment of the present invention may include a refrigerator room 10 and a refrigerator ice maker 30. The refrigerator 1 may include a cooling unit (not shown) to supply cold air to the inside of the refrigerator 10. Such a cooling unit may include, for example, an evaporator, a compressor, and a condenser. A high temperature refrigerant gas heat-exchanged with ambient air through the evaporator is sent to the compressor and compressed, and the refrigerant compressed through the compressor is liquefied while dissipating heat of condensation through the condenser. The liquefied refrigerant passing through this condenser is sent to the evaporator. The liquefied refrigerant sent to the evaporator absorbs surrounding heat, while being vaporized by heat-exchange with ambient air. The liquefied refrigerant of the evaporator receives heat from the ambient air, and the entirety or a portion of the liquefied refrigerant of the evaporator is changed into a gaseous refrigerant. Thereafter, the gaseous refrigerant is separated from the liquid refrigerant and flows back into the compressor. In the evaporator, the refrigerant absorbs heat of air outside the evaporator. Through such heat transmission, the evaporator cools air in the refrigerator. Air cooled in the evaporator is transferred to the refrigerator room 10 to cool the refrigerator room 10.

### RELATED TO THE PRESENT INVENTION

In a related art, a fruit is unnecessarily at low temperatures at the time for the user to consume the fruit kept in the storage space in the refrigerator, and thus, the fruit provided to the user who consumes the fruit cannot have the highest sugar content value. Therefore, in order to consume the fruit in a state having the highest sugar content value, the user must take the fruit out of the refrigerator before consuming it.

In order to alleviate the inconvenience, the present invention provides a fruit storage method using an artificial intelligence (AI) device to provide a fruit having the highest sugar content at a time when the user of the refrigerator consumes the fruit kept in storage in the refrigerator.

More specifically, the present invention provides a fruit storage method using an AI device, capable of obtaining information necessary to provide a fruit having the highest sugar content to a user of a refrigerator through learning, moving the fruit to a separate fruit storage space to provide the fruit having the highest sugar content on the basis of the obtained information, and setting an appropriate temperature of the separate fruit storage space, thereby providing the fruit having the highest sugar content at a time when the user consumes the fruit kept in storage in the refrigerator.

Hereinafter, a fruit storage method using an AI device provided in the present invention will be described in detail.

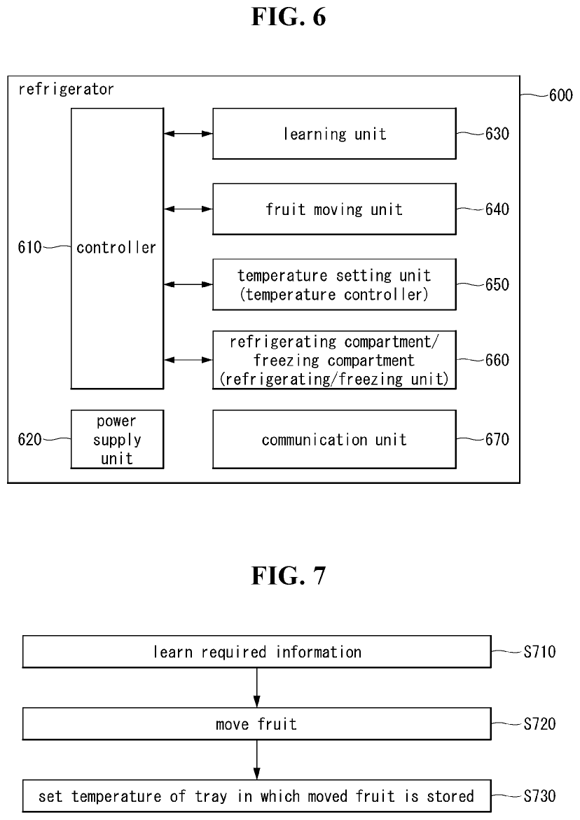

FIG. 6 is a block diagram of a refrigerator for performing a fruit storage method using an AI device according to an embodiment of the present invention.

A refrigerator 600 using an AI device according to an embodiment of the present invention includes a controller 610, a power supply unit 620, a learning unit 630, a fruit moving unit 640, a temperature controller 650, a refrigerating compartment/freezing compartment 660, and communication unit 670.

The controller 610 controls the learning unit 630, the fruit moving unit 640, the temperature controller 650, and the refrigerating compartment/freezing compartment 660. The power supply unit 620 supplies power to a dishwasher.

The learning unit 630 may include an AI processor and learn information necessary to perform the fruit storage method using the AI device provided in the present invention by using the AI processor.

In addition, the fruit moving unit 640 moves some of the fruits stored in a specific zone of a tray for storing fruits provided in the refrigerator to another specific zone of the tray. The fruit moving unit may use a moving rail to move the fruit, and may further include a unit for moving the fruit.

In addition, the temperature controller 650 sets an appropriate temperature necessary to provide the fruit having the highest sugar content value. Since temperatures having the highest sugar content value are different for each fruit type, the temperature controller may use information related to the temperatures having the highest sugar content value according to each fruit type in order for each fruit to have the highest sugar content value.

In addition, the refrigerating compartment/freezing compartment 660 refrigerates/freezes foods stored in the refrigerator. In particular, the inside of the refrigerator may be divided into one or more zones in which different temperatures may be set, respectively, in order to perform the fruit storage method using the AI device provided in the present invention. For example, the inside of the refrigerator may include a first zone in which a set temperature necessary to maintain freshness of the fruit is maintained and a second zone in which a set temperature necessary to provide the fruit having the highest sugar content is maintained. In addition, the second zone may be divided into a plurality of zones in order to simultaneously store several types of fruits to have the highest sugar content.

The communication unit 670 may communicate with an external network. Specifically, the refrigerator may identify a type of a stored fruit and transmit information related to the identified type to the external network through the communication unit. The network may AI-process the information related to the type and receive information generated as a result of processing from the network through the communication unit.

FIG. 7 is a flowchart illustrating an example of a fruit storage method using an AI device according to an embodiment of the present invention.

FIG. 7 schematically illustrates a step in which a fruit storage method using an AI device provided in the present invention is performed in a washer.

First, the controller learns information necessary to provide the fruit with the highest sugar content (S710). The necessary information may include meal pattern information of the user related to usual eating habits of the user of the refrigerator, after-meal fruit consumption pattern information of the user related to the habit of the user consuming the fruit after a meal, and temperature information related to a temperature at which a specific fruit has the highest sugar content by fruit types. The controller may obtain and store the information through learning.

Next, the controller moves the fruit to be provided to the user to a specific zone in the refrigerator in which a temperature necessary to provide the fruit having the highest sugar content is set on the basis of the necessary information (S720).

Thereafter, the controller sets a temperature of the specific zone of the refrigerator in which the moved fruit is stored to a temperature at which a sugar content of the fruit has the highest value (S730).

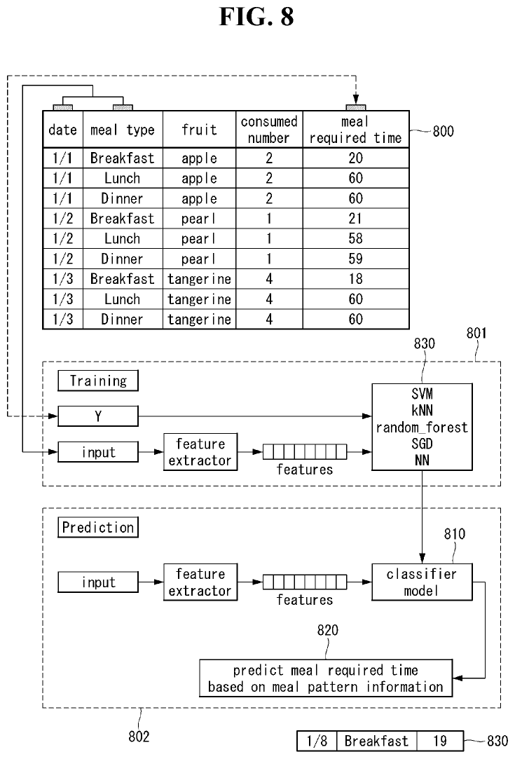

Hereinafter, steps S710 to S730 of FIG. 7 will be described in detail with reference to FIGS. 8 to 14.

For convenience of explanation, hereinafter, a temperature at which a specific fruit has the highest sugar content is referred to as a “highest sugar content temperature”. In addition, the tray for fruit storage in the refrigerator may be divided into specific zones, and among the specific zones, a zone in which fruit is stored to maintain freshness of the fruit, that is, in which the fruit is stored for a longest storage period of the fruit will be referred to as a “first zone” and a zone in which the fruit is stored to provide the fruit having the highest sugar content will be referred to as a “second zone”.

In addition, the second zone may be divided into several zones in which different temperatures are set for different types of fruits to have the highest sugar content, respectively, which are referred to as “third zones”.

In the first zone, a temperature necessary to maintain fruit freshness is set, and in the second zone, the highest sugar content temperature is set.

FIG. 8 is a view illustrating an example of performing a fruit storage method using an AI device according to an embodiment of the present invention.

FIG. 8 specifically illustrates a process in which the controller learns a meal pattern of a user of a refrigerator to obtain meal pattern information of the user and predicts a meal required time required of the user on the basis of the meal pattern information.

FIG. 8 illustrates meal pattern information 800 of the user of the refrigerator learned by the controller. The meal pattern information may be information stored by listing information regarding a date on which the user had a meal, a type of meal, a type of a fruit, and a number of fruits consumed by the user of the refrigerator.

Although not shown in FIG. 8, the meal pattern information may further include information on a meal start time and a meal end time of the user of the refrigerator.

In FIG. 8, 802 denotes a process in which the controller predicts a meal required time of the user on the basis of the meal pattern information. In 801, meal pattern information is input, and a feature extractor extracts features related to a meal pattern of the user on the basis of the received meal pattern information. When the extracted features are input to a classifier model 810 through a data classification algorithm, SVM_kNN random_forest SGD 830, result information predicting the meal required time of the user predicted on the basis of the meal pattern information is obtained (820).

A meal required time prediction result of the user predicted on the basis of the meal pattern information 830 indicates that the user's meal will take 19 minutes for breakfast on January 8.

Although not shown in FIG. 8, the meal required time prediction result may include information on a meal start time and a meal end time of the user. Alternatively, the meal start time and the meal end time are included, and the meal end time may be obtained by adding the predicted meal required time to the meal start time.

The learning and predicting process as described above may be performed by the learning unit in the refrigerator using an AI device.

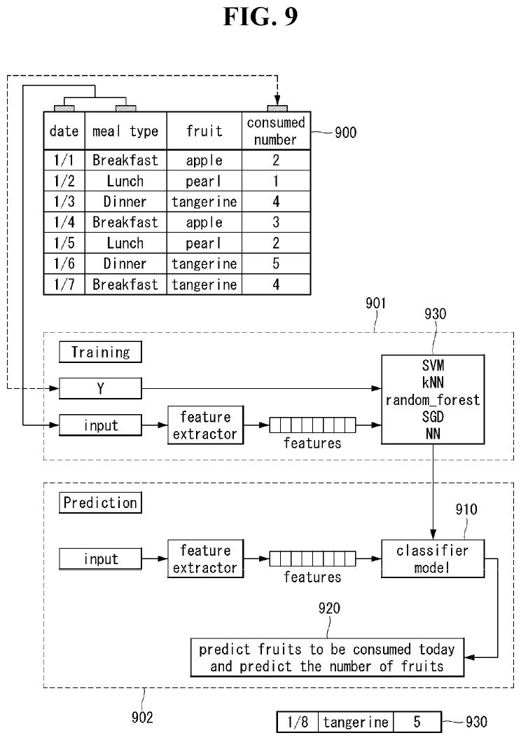

FIG. 9 is a view illustrating an example of performing a fruit storage method using an AI device according to an embodiment of the present invention.

FIG. 9 specifically shows a process in which the controller learns a fruit consumption pattern of the user of the refrigerator to obtain fruit consumption pattern information of the user and predict a fruit type and the number of fruits consumed by the user on the basis of the fruit consumption pattern information.

FIG. 9 illustrates fruit consumption pattern information 900 of the user of the refrigerator learned by the controller. The fruit consumption pattern information may be information stored by listing information on the date on which the user consumed the fruit, a type of the fruit consumed by the user, and the number of fruits consumed by the user.

Although not shown in FIG. 9, the fruit consumption pattern information may include information on the types of fruits consumed by the user and the number of fruits consumed by the user for breakfast, lunch, and dinner by dates.

In FIG. 9, 902 denotes a process of the controller predicting the type of the fruit to be consumed by a user on a specific date and the number of fruit to be consumed by a user on a specific date on the basis of the fruit consumption pattern information. In 901, fruit consumption pattern information is input, and a feature extractor extracts features related to a fruit consumption pattern of the user on the basis of the received fruit consumption pattern information. When the extracted features are input to a classifier model 910 of 902 through a data classification algorithm, SVM_kNN random_forest SGD 930, result information predicting the type of fruit to be consumed on a specific date and the number of fruits to be consumed on the specific date on the basis of the fruit consumption pattern information is obtained (920). The fruit consumption prediction result 930 of the user predicted on the basis of the fruit consumption pattern information indicates that the user will consume five tangerines on January 8.

Although not shown in FIG. 9, the fruit consumption prediction result may include information on the type and number of fruits to be consumed by the user for each meal (breakfast, lunch, and dinner). In addition, since the user may consume one or more types of fruits, the fruit consumption prediction result may include information on the consumed number of various types of fruits.

The learning and predicting process as described above may be performed by the learning unit in the refrigerator by using an AI device.

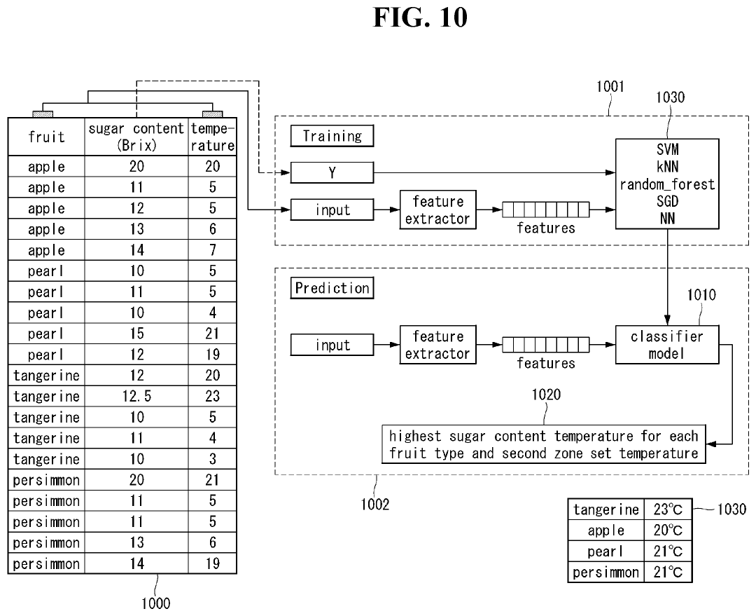

FIG. 10 is a view illustrating an example of performing a fruit storage method using an AI device according to an embodiment of the present invention.

FIG. 10 specifically illustrates a process in which the controller obtains the highest sugar content temperature information by learning a change in sugar content of a specific fruit according to a change in temperature by fruit types and sets a temperature of the second zone of the fruit storage tray in the refrigerator according to the highest sugar content temperature on the basis of the highest sugar content temperature information.

The highest sugar content temperature information 900 is shown in FIG. 10. The highest sugar content temperature information may be information stored by listing information on sugar content in accordance with fruit types and temperatures.

In FIG. 10, 1002 denotes a process in which the temperature of the second zone of the fruit storage tray in the refrigerator is set on the basis of the highest sugar content temperature information. In 1001, the highest sugar content temperature information is input, and the feature extractor extracts the features related to the temperature having the highest sugar content for each fruit type on the basis of the received highest sugar content temperature information. When the extracted features are input to the classifier model 1010 of 1002 via a data classification algorithm, SVM_kNN random_forest SGD 1030, result information indicating temperatures at which respective fruit types have the highest sugar content is obtained (1020). The result information 1030 obtained on the basis of the highest sugar content temperature information indicates that the highest sugar content temperature of tangerine is 23° C., the highest sugar content temperature of apple is 20° C., the highest sugar content temperature of pear is 21° C., and the highest sugar content temperature of persimmon is 21° C.

The highest sugar content temperature information and the result information are merely one example, and information on the highest sugar content temperature for different fruit types may further be included.

The highest sugar content temperature information may be obtained by the learning unit in the refrigerator by using an AI device, and a fruit sugar content measurement sensor may be used to measure sugar content of a fruit. In addition, the refrigerator may receive and store the highest sugar content temperature information from an external network.

Hereinafter, the step (S720) of moving the fruit stored in the first zone of the fruit storage tray in the refrigerator of FIG. 7 to the second zone and the step of (S730) of setting a temperature of the tray in which the moved fruit is stored will be described.

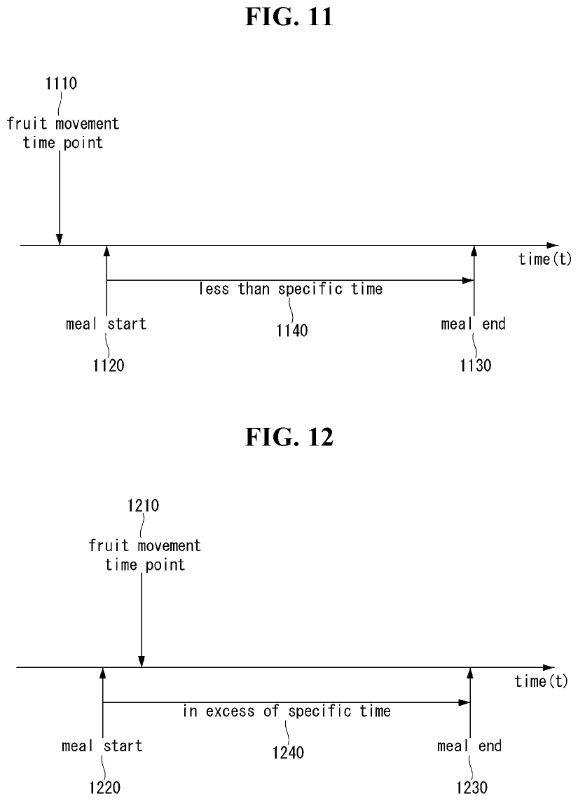

FIG. 11 is a view illustrating an example of performing a fruit storage method using an AI device according to an embodiment of the present invention.

FIG. 11 illustrates an example in which a time for moving the fruit to the second zone is determined on the basis of a time required for the meal required time of the user of the refrigerator and a refrigerating time required for the fruit determined to be consumed by the user to reach the highest sugar content temperature.

In FIG. 11, it is assumed that the user of the refrigerator consumes a fruit immediately after a meal is finished or consumes the fruit near a time point at which the meal is finished.

In addition, a specific time 1140 shown in FIG. 11 refers to a time required for a specific type of fruit kept at a specific temperature for maintaining freshness of the fruit in the first zone of the fruit storage tray in the refrigerator to be moved to the second zone and reach the highest sugar content temperature. For example, if a time required for tangerine, which is maintained at a temperature of 5° C. in the first zone for its freshness, is 1 hour necessary to reach 20° C. which is the highest sugar content temperature after movement to the second zone, the specific time may be 1 hour.

The controller may calculate the specific time through artificial intelligence. Specifically, the controller may calculate the specific time using highest sugar content value arrival time information obtained by listing a time for a specific fruit stored in the memory to reach a temperature having a highest sugar content value from a specific temperature for each fruit type.

FIG. 11 corresponds to a case where a meal required time of the user of the refrigerator (meal start time 1120 to meal end time 1130) is shorter than the specific time. Thus, in order for the user of the refrigerator to consume the fruit at the highest sugar content temperature immediately after the meal is finished, a time point 1110 at which the fruit is moved from the first zone to the second zone of the fruit storage tray in the refrigerator must be earlier than a meal start time point of the user.

Specifically, in a case where a time required for the tangerine, which is maintained at a temperature of 5° C. in the first zone for its freshness, to reach the highest sugar content temperature of 20° C. after moving to the second zone is 1 hour and the meal required time of the user of the refrigerator is 40 minutes, the fruit movement time must be 20 minutes ahead of the meal start time point of the user.

In this manner, the fruit may be appropriately moved from the first zone to the second zone of the fruit storage tray in the refrigerator on the basis of the meal required time of the user.

FIG. 12 is a view illustrating another example of performing a fruit storage method using an AI device according to an embodiment of the present invention.

FIG. 12 illustrates another example in which a time for the fruit to be moved to the second zone is determined on the basis of a meal required time of the user of the refrigerator and a refrigerating time required for a fruit determined to be consumed by the user to reach the highest sugar content temperature.

In FIG. 12, the user of the refrigerator may consume the fruit immediately after the end of the meal or consume the fruit before and after the end of the meal.

In addition, a specific time 1240 shown in FIG. 12 refers to a time required for a specific type of fruit kept at a specific temperature for maintaining freshness of the fruit in the first zone of the fruit storage tray in the refrigerator to be moved to the second zone and reach the highest sugar content temperature. For example, if a time required for apple, which is maintained at a temperature of 3° C. in the first zone for its freshness, is 1 hour and 30 minutes necessary to reach 15° C. which is the highest sugar content temperature after movement to the second zone, the specific time may be 1 hour and 30 minutes.

FIG. 12 corresponds to a case where a meal required time of the user of the refrigerator (meal start time 1220 to meal end time 1230) is longer than the specific time. Thus, in order for the user of the refrigerator to consume the fruit at the highest sugar content temperature immediately after the meal is finished, a time point at which the fruit is moved from the first zone to the second zone of the fruit storage tray in the refrigerator must be later than a meal start time point of the user.

Specifically, in a case where a time required for the apple, which is maintained at a temperature of 3° C. in the first zone for its freshness, to reach the highest sugar content temperature of 15° C. after moving to the second zone is 1 hour and 30 minutes and the meal required time of the user of the refrigerator is 1 hour and 50 minutes, the fruit movement time point must be 20 minutes behind the meal start time point of the user.

In this manner, the fruit may be appropriately moved from the first zone to the second zone of the fruit storage tray in the refrigerator on the basis of the meal required time of the user.

Unlike the examples of FIGS. 11 and 12, the time required for a specific type of fruit stored at a specific temperature to maintain freshness to be moved to the second zone to reach the highest sugar content temperature and the meal required time of the user of the refrigerator may be equal. In this case, a time point at which the fruit is moved from the first zone to the second zone of the fruit storage tray in the refrigerator may be the same as the meal start time of the user of the refrigerator.

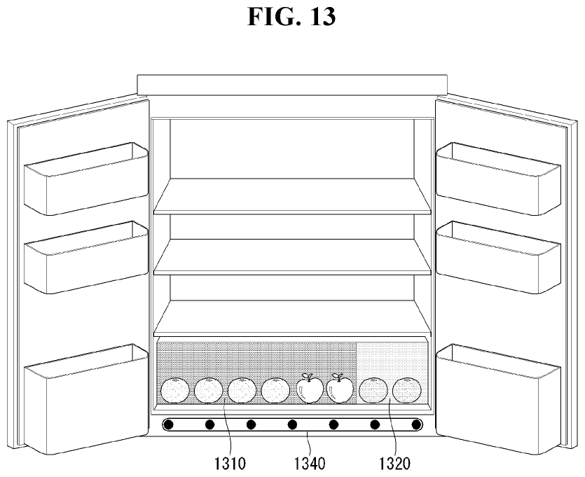

FIG. 13 is a view illustrating an example of performing a fruit storage method using an AI device according to an embodiment of the present invention.

FIG. 13 illustrates an example in which a fruit is moved from a first zone to a second zone of the fruit storage tray in the refrigerator and a temperature of the second zone in which the moved fruit is stored is set.

FIG. 13 illustrates a case where the refrigerator has only one type of fruit determined to be consumed by the user after a meal on the basis of user fruit consumption pattern information.

In FIG. 13, a first zone 1310 and a second zone 1320 of the fruit storage tray in the refrigerator are shown. The first zone is set to a specific temperature for maintaining freshness of the fruit, and here, the specific temperature may be set equal to all fruits regardless of type of fruit. The second zone is set to the highest sugar content temperature for a fruit to reach the highest sugar content, and here, the highest sugar content temperature may be set to be different depending on a type of fruit.

The refrigerator moves a specific number of one type of fruits determined to be consumed by the user after a meal on the basis of the user fruit consumption pattern information from the first zone to the second zone of the fruit storage tray of the refrigerator at a specific time point. The specific time point may be determined on the basis of meal pattern information of the user.

The fruit may be moved through a moving rail provided in the refrigerator. However, the present invention may include a variety of units for moving fruit, without being limited to the above examples.

Specifically, in FIG. 13, tangerines and apples are stored in the first zone of the fruit storage tray, and the refrigerator determines that the user will consume two tangerines after a meal on the basis of the user fruit consumption pattern information and moves two tangerines from the first zone to the second zone of the fruit storage tray of the refrigerator.

After the fruit is moved from the first zone to the second zone, the refrigerator may set the temperature of the second zone to the highest sugar content temperature at which the fruit has the highest sugar content value, and the temperature may be set by a temperature controller.

In order for the refrigerator to set the second zone to the highest sugar content temperature, the second zone of the refrigerator may have a fruit recognition sensor for identifying a fruit type, and as the fruit recognition sensor identifies a fruit type, the temperature controller of the second zone may set the temperature of the second zone to the highest sugar content temperature. Here, in order to set the highest sugar content temperature, the highest sugar content temperature information may be used.

The information on a specific time required to reach the highest sugar content temperature may be included in the highest sugar content temperature information. The information on the specific time may be included for each fruit type.

That is, the refrigerator may determine a specific time point at which a fruit is to be moved from the first zone to the second zone on the basis of the information on the highest sugar content temperature included in the highest sugar content temperature information, the meal start time information included in the meal pattern information of the user, and the fruit consumption pattern information of the user.

Alternatively, the fruit consumption pattern information of the user may be transferred to the temperature controller of the second zone, so that the temperature controller of the second zone may identify the fruit moved to the second zone on the basis of fruit type information included in the fruit consumption pattern information and set the temperature of the second zone to the highest sugar content temperature according to the identified fruit type. Here, in order to set the highest sugar content temperature, the highest sugar content temperature information may be used.

Information on a specific time required to reach the highest sugar content temperature may be included in the highest sugar content temperature information.

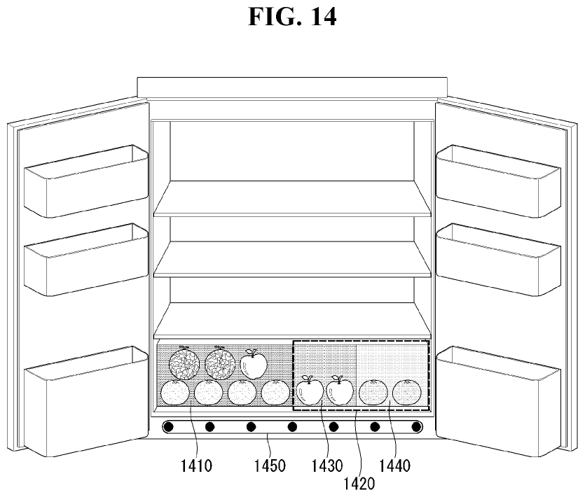

FIG. 14 is a view illustrating another example of performing a fruit storage method using an AI device according to an embodiment of the present invention.

FIG. 14 illustrates an example in which a fruit is moved from a first zone to a second zone of a fruit storage tray in a refrigerator and a temperature of the second zone in which the moved fruit is stored is set.

FIG. 14 shows a case where there are two types of fruits that the controller determines to be consumed by the user after a meal on the basis of the user fruit consumption pattern information. The example of FIG. 14 may also be extendedly applied to a case where the refrigerator determines that more than two types of fruits are to be consumed by the user after a meal, as well as to the case where two types of fruits are determined to be consumed by the user after a meal on the basis of the user fruit consumption pattern information.

In FIG. 14, a first zone 1410 and a second zone 1420 of the fruit storage tray in the refrigerator are shown. The first zone is set to a specific temperature for maintaining freshness of a fruit, and the specific temperature may be set equal to all fruits regardless of type of fruit.

In addition, the second zone may be divided into two third zones to store two different types of fruits and to set different highest sugar content temperatures for each of the two different types of fruits. The two third zones are each set to the highest sugar content temperature for reaching the highest sugar content of different types of fruits, and the highest sugar content temperature is set to be different depending on a type of a fruit.

The controller moves a specific number of two types of fruits determined to be consumed by the user after a meal by from the first zone to the second zone of the fruit storage tray of the refrigerator on the basis of the user fruit consumption pattern information at a specific point in time. The specific time point may be determined on the basis of the meal pattern information of the user. In addition, since the time for each fruit type to reach the highest sugar content temperature may be different, a time point for each fruit type to move from the first zone to the second zone may be different.

The fruit may be moved through a moving rail provided in the refrigerator. However, the present invention may include a variety of units for moving fruit, without being limited to the above examples.

In detail, in FIG. 14, tangerines, apples, and melons are stored in the first zone of the fruit storage tray, and the controller determines that the user will consume two tangerines and two apples after a meal on the basis of the user fruit consumption pattern information and moves two tangerines and two apples from the first zone of the fruit storage tray of the refrigerator to the third zones included in the second zone at each specific time point. In this case, since a time at which the apples and tangerines reach the highest sugar content temperature from a temperature for maintaining freshness may be different, the specific time point at which the apples and tangerines are moved to the third zone may be different.

After the two types of fruits are respectively moved from the first zone to the third zones included in the second zone, the controller sets the temperatures of the third zones included in the second zone to the highest sugar content temperatures at which the two types of fruits have the highest sugar content values, respectively, and the temperatures may be set by the temperature controller.

In order for the controller to set the temperatures of the third zones included in the second zone to different highest sugar content temperatures on the basis of the types of the fruits, a fruit recognition sensor for identifying a type of a fruit may be provided in the second zone of the refrigerator. As the fruit recognition sensor identifies the types of the fruits, the temperature controller of the second zone may set the temperatures of the third zones included in the second zone to the different highest sugar content temperatures on the basis of the types of the fruits. Here, in order to set the highest sugar content temperatures, the highest sugar content temperature information may be used.

Alternatively, the fruit consumption pattern information of the user may be transferred to the temperature controller of the second zone, so that the temperature controller of the second zone may identify the fruits moved to the second zone on the basis of the fruit type information included in the fruit consumption pattern information and set the temperatures of the third zones included in the second zone to different highest sugar content temperatures according to the identified fruit types. Here, in order to set the highest sugar content temperatures, the highest sugar content temperature information may be used.

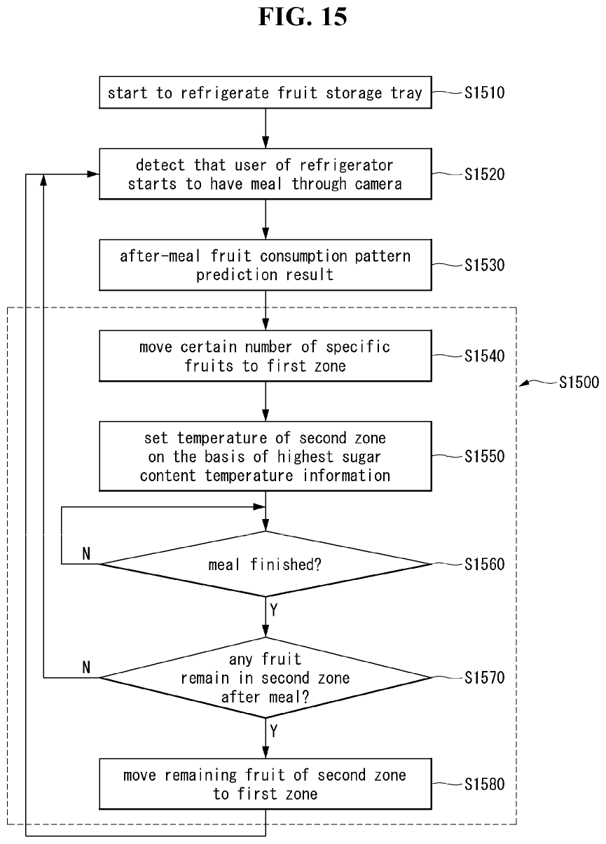

FIG. 15 is a flowchart illustrating an example of a fruit storage method using an AI device according to an embodiment of the present invention.

The controller starts to refrigerate the fruit storage tray (S1510).

Next, the controller detects that the user of the refrigerator starts to have a meal through a camera provided in the refrigerator (S1520).

Upon detecting that the user of the refrigerator starts to have a meal, the controller predicts an after-meal fruit consumption pattern of the user (S1530). The after-meal fruit consumption pattern of the user may be predicted on the basis of the fruit consumption pattern information.

As a result of predicting the after-meal fruit consumption pattern of the user, the controller obtains a result that the user will consume a certain number of specific fruits.

On the basis of the prediction result, in order to cause the specific fruit to reach the highest sugar content temperature, the controller moves a certain number of specific fruits among the fruits stored in the fruit storage tray from the first zone to the second zone of the fruit storage tray (S1540). Here, the controller may move the specific fruits from the first zone to the second zone at a specific time point determined on the basis of the meal pattern information of the user so that the user of the refrigerator may immediately consume the fruits having the highest sugar content values immediately after the meal.

Next, the controller sets a temperature of the second zone to the highest sugar content temperature in order to cause the certain number of specific fruits moved to the second zone to reach highest sugar content temperatures (S1550). In this case, the controller may use the highest sugar content temperature information to set the temperature of the second zone to the highest sugar content temperature.

The controller determines whether the user's meal is finished (S1560). Here, the controller may determine whether the meal is finished on the basis of an image captured by the camera provided in the refrigerator. Alternatively, if an estimated end time has lapsed on the basis of the meal pattern information of the user of the refrigerator, the controller may determine that the meal is finished.

If it is determined that the meal is not finished, step S1560 is performed again. Meanwhile, if it is determined that the meal is finished, it is determined whether there is any fruit remaining in the second zone of the fruit storage tray of the refrigerator after the meal is finished (S1570). Here, the controller may use a fruit recognition sensor provided in the refrigerator to determine whether the fruit remains in the second zone.

If it is determined that no fruit remains in the second zone, the controller repeats the procedure again from step S1520.

Meanwhile, if it is determined that a fruit remains in the second zone, the controller moves the remaining fruit of the second zone back to the first zone (S1580).

The controller may perform the procedure of S1500 each time before and after the user's meal time.

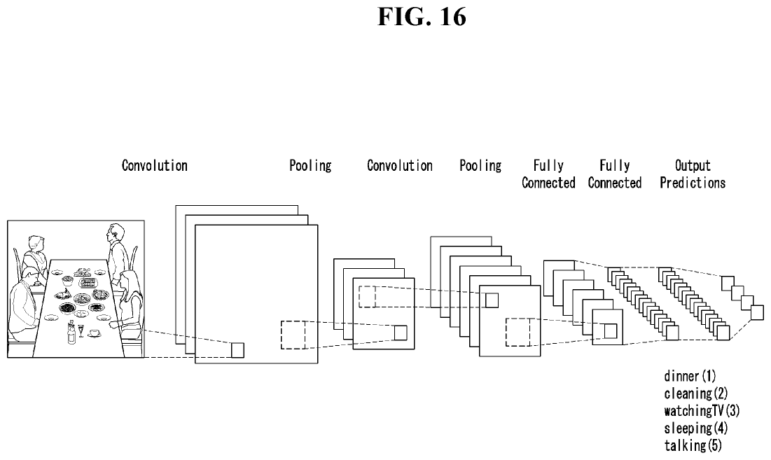

FIG. 16 shows an example of performing a fruit storage method using an AI device according to an embodiment of the present invention.

FIG. 16 specifically illustrates a method of detecting that the user of the refrigerator starts to have a meal through a camera image of FIG. 15.

The controller may learn a screen image of the user of the refrigerator who is eating through a camera provided in the refrigerator. The controller may capture an image of the user of the refrigerator in step S1520 of FIG. 15, and determine whether the user of the refrigerator currently starts a meal on the basis of the learned result.

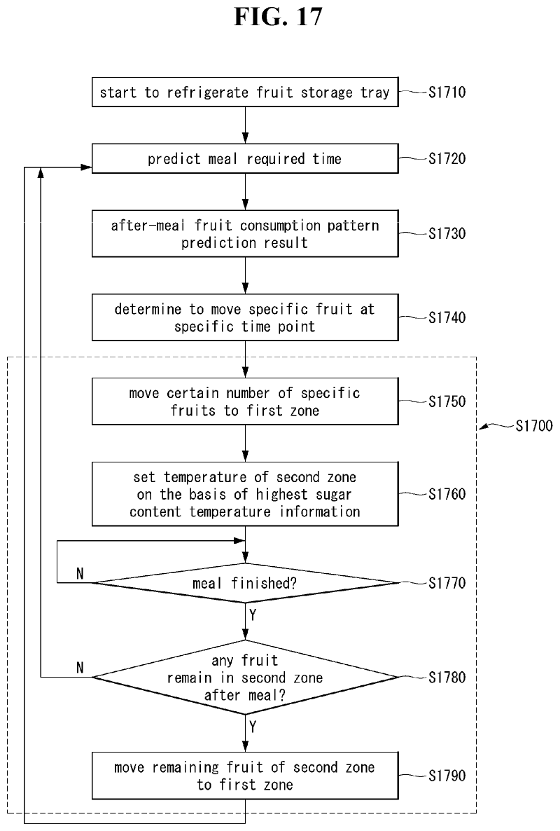

FIG. 17 is a flowchart illustrating an example of a fruit storage method using an AI device according to an embodiment of the present invention.

In FIG. 17, it is assumed that a user's meal time is 19 minutes and a time required for a specific fruit to reach the highest sugar content temperature is 1 hour.

The controller starts to refrigerate the fruit storage tray (S1700).

Next, the controller predicts a meal required time of the user of the refrigerator on the basis of the meal pattern information of the user (S1710). In this case, the controller may predict an estimated meal start time and an estimated meal end time of the user of the refrigerator. As a result of the prediction, the controller determines that the user of the refrigerator takes 19 minutes for a meal.

Upon detecting that the user starts to have a meal, the controller predicts an after-meal fruit consumption pattern of the user (S1720). The after-meal fruit consumption pattern of the user may be predicted on the basis of the fruit consumption pattern information.

As a result of predicting the after-meal fruit consumption pattern of the user, the controller obtains a result that the user will consume a certain number of specific fruits.

The steps S1710 and S1720 may be performed simultaneously or may be performed in a reversed order.

The controller determines a specific time point for moving a fruit from the first zone to the second zone so that the user of the refrigerator may immediately consume the fruit having the highest sugar content value immediately after the meal (S1730). Here, in order to determine the specific time point, the controller may use the user's meal pattern information, fruit consumption pattern information, and highest sugar content temperature information. The highest sugar content temperature information may include information on a time required for a specific type of fruit to reach the highest sugar content temperature at a specific temperature.

In the example of FIG. 17, since the time required for the temperature of the specific fruit to reach the highest sugar content temperature from the temperature for maintaining freshness is 1 hour, the controller may move a certain number of specific fruits from the first zone to the second zone 41 minutes before the user's meal time.

In order to ensure that the specific fruit reaches the highest sugar content temperature at the meal end time point of the user on the basis of the prediction result, the controller moves a certain number of fruits stored in the fruit storage tray from the first zone to the second zone of the fruit storage tray 41 minutes before the user's meal start time (S1740).

Next, the controller sets the temperature of the second zone to the highest sugar content temperature in order to cause the certain number of specific fruits moved to the second zone to reach the highest sugar content temperature (S1750). Here, the controller may use the highest sugar content temperature information to set the temperature of the second zone to the highest sugar content temperature.

The controller determines whether the user's meal is finished (S1760). Here, when an estimated end time has lapsed on the basis of the meal pattern information of the user of the refrigerator, the controller may determine that the meal is finished.

If it is determined that the meal is not finished yet, step S1760 is performed again. Meanwhile, if it is determined that the meal is finished, the controller determines whether there is any fruit remaining in the second zone of the fruit storage tray of the refrigerator after the meal is finished (S1770). Here, the controller may use the fruit recognition sensor provided in the refrigerator to determine whether the fruit remains in the second zone.

If it is determined that no fruit remains in the second zone, the controller repeats the procedure again from step S1720.

Meanwhile, if it is determined that the fruit remains in the second zone, the controller moves the remaining fruit of the second zone back to the first zone (S1780).

The controller may perform the procedure of S1700 each time before and after the meal time of the user.

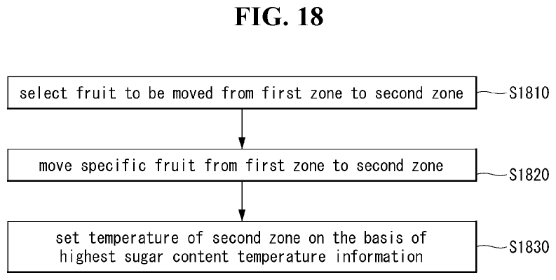

FIG. 18 is a flowchart illustrating an example of a fruit storage method using an AI device according to an embodiment of the present invention.

First, the controller of the refrigerator selects a specific fruit to be moved from the first zone to the second zone of the tray in which fruits are stored in the refrigerating compartment on the basis of the fruit consumption pattern information of the user (S1810).

Next, the controller moves the specific fruit from the first zone to the second zone through a rail provided at a lower end of the tray at a specific time predicted on the basis of the meal pattern information of the user (S1820).

Thereafter, the controller sets a temperature of the second zone so that the fruit has the highest sugar content value on the basis of the highest sugar content temperature information (S1830).

Embodiment 1: An intelligent refrigerator includes: a refrigerator compartment; a memory storing meal pattern information of a user, fruit consumption pattern information, and highest sugar content temperature information; a tray in which a fruit is stored in the refrigerator compartment; a rail provided at a lower end portion of the tray and controlling movement of the fruit between a first zone and a second zone of the tray; and a controller controlling movement of the rail so that a fruit selected on the basis of the fruit consumption pattern information is moved from the first zone to the second zone at a specific time point predicted on the basis of the meal pattern information of the user, wherein the second zone is a space in which a temperature is controlled so that the fruit has a highest sugar content value on the basis of the highest sugar content temperature information.

Embodiment 2: In embodiment 1, the meal pattern information may include information in which information on a meal start time point, a meal end time point, and a meal required time of the user recorded by meals is listed by specific dates.

Embodiment 3: In embodiment 1, the fruit consumption pattern information may include at least one of date information on which the user consumes a specific fruit, type information of the specific fruit, and information on the consumed number of the specific fruit.

Embodiment 4: In embodiment 1, the highest sugar content temperature information may include information in which a temperature at which a specific fruit has the highest sugar content value is listed by fruits.

Embodiment 5: In embodiment 1, the first zone may be a space in which a temperature is controlled to maximize a storage period of the fruit.

Embodiment 6: In embodiment 1, the memory may further store a highest sugar content value arrival time information listing a time taken for a specific fruit to reach a temperature having a highest sugar content value from a specific temperature by fruit types, and the controller may calculate the highest sugar content value arrival time required for the fruit to reach a temperature having the highest sugar content value from a temperature of the first zone on the basis of the highest sugar content value arrival time information.

Embodiment 7: In embodiment 6, if the highest sugar content value arrival time is shorter than the meal required time of the user, the specific time point may be later than the meal start time of the user.

Embodiment 8: In embodiment 6, if the highest sugar content value arrival time is longer than the meal required time, the specific time point may be earlier than the meal start time of the user.

Embodiment 9: In embodiment 6, if the highest sugar content value arrival time is equal to the meal required time of the user, the specific time point may be equal to the meal start time of the user.

Embodiment 10: In embodiment 1, the intelligent refrigerator may further include: a camera detecting that the user starts to have a meal.

Embodiment 11: In embodiment 1, the controller may identify a type of the fruit moved to the second zone.

Embodiment 12: In embodiment 11, the controller may identify the type of the fruit on the basis of the fruit consumption pattern information.

Embodiment 13: In embodiment 11, the intelligent refrigerator may further include: a fruit recognition sensor, wherein the controller may control the fruit recognition sensor to identify the type of the fruit.

Embodiment 14: In embodiment 1, the controller may control the rail to move the fruit of the second zone to the first zone if the user does not consume the fruit for a predetermined time after the meal end time point.

Embodiment 15: In embodiment 11, the intelligent refrigerator may further include: a communication unit, wherein the controller may control the communication unit to receive downlink control information (DCI) used for scheduling transmission of information on the type of the fruit from a network, and the information on the type of the fruit may be transmitted to the network on the basis of the DCI.

Embodiment 16: In embodiment 15, the controller may control the communication unit to perform an initial access procedure with the network on the basis of a synchronization signal block (SSB), the information on the type of the fruit may be transmitted to the network through a physical uplink shared channel (PUSCH), and the SSB and a demodulation reference signal (DM-RS) of the PUSCH may be quasi-co-located, QCL, for a QCL type D.

Embodiment 17: In embodiment 15, the controller may control the communication unit to transmit information on the type of the fruit to an AI processor included in the network, and the controller may control the communication unit to receive the highest sugar content temperature information in which information regarding the type of the fruit is AI-processed from the AI processor.

Embodiment 18: a fruit storage method using an artificial intelligence device, includes: selecting a specific fruit to be moved from a first zone to a second zone of a tray storing a fruit in a refrigerating compartment on the basis of fruit consumption pattern information of a user; moving the specific fruit from the first zone to the second zone through a rail provided at a lower end portion of the tray at a specific time point predicted on the basis of meal pattern information of the user; and setting a temperature of the second zone such that the fruit has the highest sugar content value on the basis of the highest sugar content temperature information.

Embodiment 19: In embodiment 18, the meal pattern information may include information in which information on a meal start time point, a meal end time point, and a meal required time of the user recorded by meals is listed by specific dates.

Embodiment 20: In embodiment 18, the fruit consumption pattern information may include at least one of date information on which the user consumes a specific fruit, type information of the specific fruit, and information on the consumed number of the specific fruit.

Embodiment 21: In embodiment 18, the highest sugar content temperature information may include information in which a temperature at which a specific fruit has the highest sugar content value is listed by fruits.

Embodiment 22: In embodiment 18, the first zone may be a space in which a temperature is controlled to maximize a storage period of the fruit.

Embodiment 23: In embodiment 18, the method may further include: calculating a highest sugar content value arrival time required for a specific fruit to reach a temperature having a highest sugar content value from a temperature of the first zone on the basis of the highest sugar content value arrival time information listing a time for the specific fruit to reach the temperature having the highest sugar content value from a specific temperature by fruit type.

Embodiment 24: In embodiment 23, if the highest sugar content value arrival time is shorter than the meal required time of the user, the specific time point may be later than the meal start time of the user.

Embodiment 25: In embodiment 23, if the highest sugar content value arrival time is longer than the meal required time, the specific time point may be earlier than the meal start time of the user.

Embodiment 26: In embodiment 23, if the highest sugar content value arrival time is equal to the meal required time of the user, the specific time point may be equal to the meal start time of the user.

Embodiment 27: In embodiment 18, the method may further include: detecting that the user starts to have a meal through a camera.

Embodiment 28: In embodiment 18, the method may further include: identifying a type of the fruit moved to the second zone.

Embodiment 29: In embodiment 28, the type of the fruit may be identified on the basis of the fruit consumption pattern information

Embodiment 30: In embodiment 28, the type of the fruit may be identified by a fruit recognition sensor.

Embodiment 31: In embodiment 18, the method may further include: moving the specific fruit from the second zone to the first zone if the user does not consume the specific fruit for a predetermined time after the meal end time point.

Embodiment 32: In embodiment 28, the method may further include: receiving downlink control information (DCI) used for scheduling transmission of information on the type of the fruit from a network, wherein the information on the type of the fruit may be transmitted to the network on the basis of the DCI.

Embodiment 33: In embodiment 32, The method may further include: performing an initial access procedure with the network on the basis of a synchronization signal block (SSB), wherein the information on the type of the fruit may be transmitted to the network through a physical uplink shared channel (PUSCH) and the SSB and a demodulation reference signal (DM-RS) of the PUSCH may be quasi-co-located, QCL, for a QCL type D.

Embodiment 34: In embodiment 32, The method may further include: transmitting information on the type of the fruit to an AI processor included in the network; and receiving the highest sugar content temperature information in which information regarding the type of the fruit is AI-processed from the AI processor.

Effects of the intelligent refrigerator according to the present invention are as follows. According to at least one of embodiments of the present invention, a fruit having the highest sugar content value may be provided when a user of a user of the refrigerator consumes the fruit. According to at least one of embodiments of the present invention, a meal pattern of a user of a refrigerator may be learned in order to provide a fruit having the highest sugar content value at a time when the user consumes the fruit. According to at least one of embodiments of the present invention, an after-meal fruit consumption pattern of a user of a refrigerator may be learned to provide fruit having the highest sugar content value at a time when the user consumes the fruit. According to at least one of embodiments of the present invention, fruit having the highest sugar content value may be provided on the basis of a meal pattern of a user and an after-meal fruit consumption pattern of the user.

Effects of the fruit storage method using an AI device according to the present invention are as follows. According to at least one of embodiments of the present invention, a fruit having the highest sugar content value may be provided when a user of a user of the refrigerator consumes the fruit. According to at least one of embodiments of the present invention, a meal pattern of a user of a refrigerator may be learned in order to provide a fruit having the highest sugar content value at a time when the user consumes the fruit. According to at least one of embodiments of the present invention, an after-meal fruit consumption pattern of a user of a refrigerator may be learned to provide fruit having the highest sugar content value at a time when the user consumes the fruit. According to at least one of embodiments of the present invention, fruit having the highest sugar content value may be provided on the basis of a meal pattern of a user and an after-meal fruit consumption pattern of the user.

The present invention described above may be implemented as a computer-readable code in a medium in which a program is recorded. The computer-readable medium includes any type of recording device in which data that can be read by a computer system is stored. The computer-readable medium may be, for example, a hard disk drive (HDD), a solid state disk (SSD), a silicon disk drive (SDD), a ROM, a RAM, a CD-ROM, a magnetic tape, a floppy disk, an optical data storage device, and the like. The computer-readable medium also includes implementations in the form of carrier waves (e.g., transmission via the Internet). Also, the computer may include the controller 180 of the terminal. Thus, the foregoing detailed description should not be interpreted limitedly in every aspect and should be considered to be illustrative. The scope of the present invention should be determined by reasonable interpretations of the attached claims and every modification within the equivalent range are included in the scope of the present invention.

The features, structures, effects, and the like described in the above-described embodiments include at least one embodiment of the present invention, but the present invention is not limited only to one embodiment. Further, the features, structures, effects, and the like illustrated in each embodiment may be combined or modified to other embodiments by those skilled in the art. Therefore, contents related to the combination or the modification should be interpreted to be included in the scope of the invention.

In addition, while the present invention has been particularly described with reference to exemplary embodiments, the present invention is not limited thereto. It will be understood by those skilled in the art that various modifications and applications, which are not illustrated in the above, may be made without departing from the spirit and scope of the present invention. For example, each component illustrated in the embodiments may be modified and made. It should be interpreted that differences related to these modifications and applications are included in the scope of the invention defined in the appended claims.

In the above exemplary systems, although the methods have been described on the basis of the flowcharts using a series of the steps or blocks, the present invention is not limited to the sequence of the steps, and some of the steps may be performed at different sequences from the remaining steps or may be performed simultaneously with the remaining steps. Furthermore, those skilled in the art will understand that the steps shown in the flowcharts are not exclusive and may include other steps or one or more steps of the flowcharts may be deleted without affecting the scope of the present invention.

The present invention has an effect of providing a fruit having the highest sugar content value when a user of a user of the refrigerator consumes the fruit.

Further, the present invention has an effect of learning a meal pattern of a user of a refrigerator in order to provide a fruit having the highest sugar content value at a time when the user consumes the fruit.

Further, the present invention has an effect of learning an after-meal fruit consumption pattern of a user of a refrigerator to provide fruit having the highest sugar content value at a time when the user consumes the fruit.

Further, the present invention has an effect of providing a fruit having the highest sugar content value on the basis of a meal pattern of a user and an after-meal fruit consumption pattern of the user.

What is claimed is:

1. An intelligent refrigerator comprising:
a refrigerator compartment;
a memory storing meal pattern information of a user, fruit consumption pattern information, and highest sugar content temperature information;
a tray in which a fruit is stored in the refrigerator compartment;
a rail provided at a lower end portion of the tray and controlling movement of the fruit between a first zone and a second zone of the tray; and
a controller controlling movement of the rail so that a fruit selected on the basis of the fruit consumption pattern information is moved from the first zone to the second zone at a specific time point predicted on the basis of the meal pattern information of the user,
wherein the second zone is a space in which a temperature is controlled so that the fruit has a highest sugar content value on the basis of highest sugar content temperature information.

2. The intelligent refrigerator of claim 1, wherein
the meal pattern information comprises information in which information on a meal start time point, a meal end time point, and a meal required time of the user recorded by meals is listed by specific dates.

3. The intelligent refrigerator of claim 1, wherein
the fruit consumption pattern information comprises at least one of date on which the user consumes a specific fruit, type information of the specific fruit, and the consumed number of the specific fruit.

4. The intelligent refrigerator of claim 1, wherein
the highest sugar content temperature information comprises information in which a temperature at which a specific fruit has a highest sugar content value is listed by fruits.

5. The intelligent refrigerator of claim 1, wherein
the first zone is a space in which a temperature is controlled to maximize a storage period of the fruit.

6. The intelligent refrigerator of claim 1, wherein
the memory further stores a highest sugar content value arrival time information listing a time taken for a specific fruit to reach a temperature having a highest sugar content value from a specific temperature by fruit types, and
the controller calculates a highest sugar content value arrival time required for the fruit to reach a temperature having the highest sugar content value from a temperature of the first zone on the basis of a highest sugar content value arrival time information.

7. The intelligent refrigerator of claim 6, wherein
if the highest sugar content value arrival time is shorter than the meal required time of the user, the specific time point is later than the meal start time of the user.

8. The intelligent refrigerator of claim 6, wherein
if the highest sugar content value arrival time is longer than the meal required time, the specific time point is earlier than the meal start time of the user.

9. The intelligent refrigerator of claim 6, wherein
if the highest sugar content value arrival time is equal to the meal required time of the user, the specific time point is equal to the meal start time of the user.

10. The intelligent refrigerator of claim 1, further comprising:
a camera detecting that the user starts to have a meal.

11. The intelligent refrigerator of claim 1, wherein
the controller identifies a type of the fruit moved to the second zone.

12. The intelligent refrigerator of claim 11, wherein
the controller identifies the type of the fruit on the basis of the fruit consumption pattern information.

13. The intelligent refrigerator of claim 11, further comprising:
a fruit recognition sensor,
wherein the controller controls the fruit recognition sensor to identify the type of the fruit.

14. The intelligent refrigerator of claim 1, wherein
the controller controls the rail to move the fruit of the second zone to the first zone if the user does not consume the fruit for a predetermined time after the meal end time point.

15. The intelligent refrigerator of claim 11, further comprising:
a communication unit,
wherein the controller controls the communication unit to receive downlink control information (DCI) used for scheduling transmission of information on the type of the fruit from a network, and
the information on the type of the fruit is transmitted to the network on the basis of the DCI.

16. The intelligent refrigerator of claim 15, wherein
the controller controls the communication unit to perform an initial access procedure with the network on the basis of a synchronization signal block (SSB),
the information on the type of the fruit is transmitted to the network through a physical uplink shared channel (PUSCH), and
the SSB and a demodulation reference signal (DM-RS) of the PUSCH is quasi-co-located, QCL, for a QCL type D.

17. The intelligent refrigerator of claim 15, wherein
the controller controls the communication unit to transmit information on the type of the fruit to an AI processor included in the network, and
the controller controls the communication unit to receive the highest sugar content temperature information in which information regarding the type of the fruit is AI-processed from the AI processor.

18. A fruit storage method using an artificial intelligence device, the fruit storage method comprising:
selecting a specific fruit to be moved from a first zone to a second zone of a tray storing a fruit in a refrigerating compartment on the basis of fruit consumption pattern information of a user;
moving the specific fruit from the first zone to the second zone through a rail provided at a lower end portion of the tray at a specific time point predicted on the basis of meal pattern information of the user; and
setting a temperature of the second zone such that the fruit has the highest sugar content value on the basis of the highest sugar content temperature information.

19. The fruit storage method of claim 18, further comprising:
calculating a highest sugar content value arrival time required for a specific fruit to reach a temperature having a highest sugar content value from a temperature of the first zone on the basis of the highest sugar content value arrival time information listing a time for the specific fruit to reach the temperature having the highest sugar content value from a specific temperature by fruit types.

20. The fruit storage method of claim 18, further comprising:
moving the specific fruit from the second zone to the first zone if the user does not consume the specific fruit for a predetermined time after the meal end time point.
